(19) United States
(12) Patent Application Publication
(10) Pub. No.: US 2009/0030667 A1
(43) Pub. Date: Jan. 29, 2009

(54) REAL-TIME DISCRETE EVENT SIMULATION WITH LOCATION TRACKING

(75) Inventors: Mansour TOLOO, Palatine, IL (US); Thomas S. Babin, Lake Zurich, IL (US); Julius S. Gyorfi, Vernon Hills, IL (US); Swee M. Mok, Palatine, IL (US); Francesca Schuler, DesPlaines, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/829,559

(22) Filed: Jul. 27, 2007

(51) Int. Cl. G06G 7/62

(52) U.S. Cl. 703/17

(57) ABSTRACT

A machine-implemented method for simulating a supply chain for a product may include receiving real-time information regarding delays from at least one link in a product supply chain, simulating events in a supply chain based on the received information, and determining, based on the simulation, whether the costs and/or level of service relative to the product is unacceptable.

### TECHNICAL FIELD

The present invention is directed generally to supply chain process models. More particularly, the present invention is directed to methods and apparatuses for improving supply chain cost models via real-time discrete event simulation using location-tracking technologies.

### BACKGROUND

A supply chain involves coordination of elements along a value chain providing goods and services in correct quantities, to appropriate locations, and at the right time in order to satisfy service level requests while minimizing system-wide costs. Supply chain simulation attempts to mimic real events and operations, enabling a step-by-step walkthrough of the process and activities for a given time interval of interest. Supply chain simulation tools can be connected to supply chain cost modeling tools that facilitate decision making at the strategic level, as well as evaluating and analyzing end-to-end cost.

From a strategic viewpoint, supply chain organizations require tools that aid in the understanding of the end-to-end supply chain costs and the impact of varying parameters such as product demand, changes in manufacturing/distribution center sourcing networks, market strategies (e.g., tax/duty structures), manufacturing strategies (e.g., efficient, lean, detailed, etc.), distribution strategies (e.g., order processing mechanisms, ABC classification, etc.), pricing strategies, transportation networks, and logistics networks. Optimizing these parameters ensures that new product information, financial performance, and projected financial performance for existing products are maximized.

Some conventional approaches to supply chain simulation include simulating a time-dependent progression of events to predict a specified output based on the given inputs and the details implemented. A Design of Experiments (DOE) and Sensitivity Analysis (SA) can be conducted to study the variation in the output(s) of a model, qualitatively or quantitatively, to different sources of variation. The output(s) can be numerical or otherwise. The simulation can also be analyzed using other Six-Sigma analysis methodologies. Such Six-Sigma methodologies may include Analysis of Variance (ANOVA), response surface methods (RSM), etc.

However, conventional simulation models do not perform real-time discrete event simulation. Instead, conventional simulation models passively collect and analyze past historical data to obtain transportation delay parameters that serve as inputs to the discrete event simulation environment in order to best assess the current state and predict future performance.

Thus, it may be desirable to provide methods and apparatuses for supply chain simulation using location-tracking technologies to enable real-time discrete event simulation. The methods and apparatuses may provide the most up to date simulation results based on the most current inventory and transportation details. It may be desirable to provide the ability to alert a user of changes in transportation details and the changed inputs that lead to the alert.

### SUMMARY OF THE INVENTION

According to various aspects of the disclosure, a machine-implemented method for simulating a supply chain for a product may include receiving real-time information regarding delays from at least one link in a product supply chain, simulating events in a supply chain based on the received information, and determining, based on the simulation, whether the costs and/or level of service relative to the product is unacceptable.

In accordance with some aspects of the disclosure, a processing device may comprise at least one processor, a memory, and a bus. The memory may include instructions for the processor, and the bus may provide communication between the processor and the memory. The memory may further comprise instructions for receiving real-time information regarding delays from at least one link in a product supply chain, simulating events in a supply chain based on the received information, and determining, based on the simulation, whether the costs and/or level of service relative to the product is unacceptable.

According to some aspects of the disclosure, a tangible, machine-readable medium may include instructions for at least one processor recorded thereon. The medium may comprise instructions for receiving real-time information regarding delays from at least one link in a product supply chain, instructions for simulating events in a supply chain based on the received information, and instructions for determining, based on the simulation, whether the costs and/or level of service relative to the product is unacceptable.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of a computer system having an exemplary supply chain optimization module in accordance with a possible embodiment of the invention;

FIG. 2 illustrates a block diagram of exemplary inputs to and outputs from an exemplary discrete event simulation and statistical analysis module in accordance with a possible embodiment of the invention;

FIG. 3 illustrates a block diagram of an exemplary wide area location tracking infrastructure in accordance with a possible embodiment of the invention; and

FIG. 4 is an exemplary flowchart illustrating an exemplary supply chain simulation process in accordance with one possible embodiment of the invention.

### DETAILED DESCRIPTION

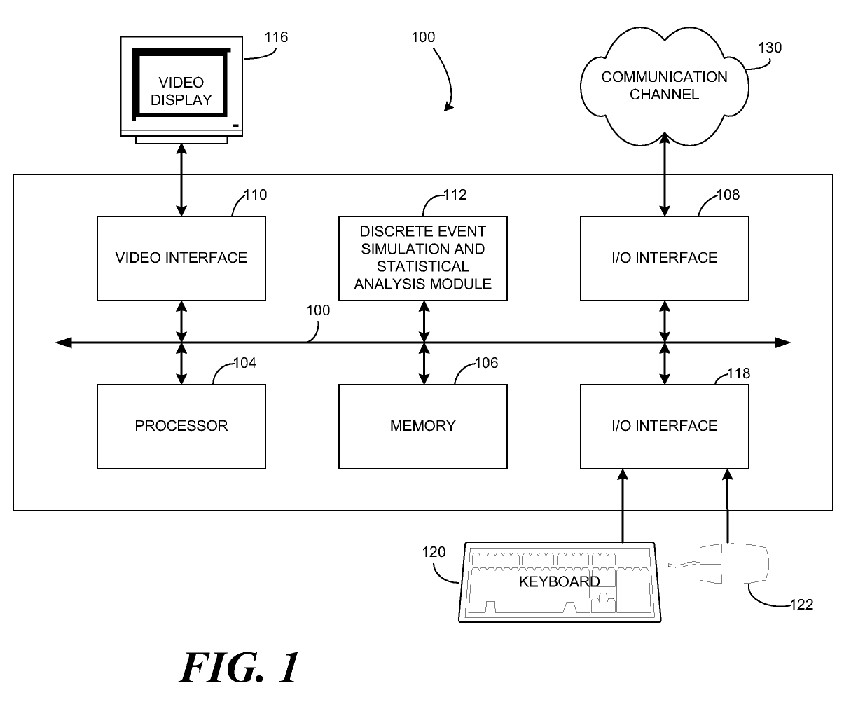

FIG. 1 illustrates a block diagram of an exemplary computer system 100 having a discrete event simulation and statistical analysis module 112 in accordance with a possible embodiment of the invention. Various embodiments of the disclosure may be implemented using a processing device 102, such as, for example, a general-purpose computer, as shown in FIG. 1.

The computer system 100 may include the processing device 102, a display 116, and input devices 120, 122. In addition, the computer system 100 can have any of a number of other output devices including line printers, laser printers, plotters, and other reproduction devices connected to the processing device 102. The computer system 100 can be connected to one or more other computers via a communication interface 108 using an appropriate communication channel 130 such as, for example, a computer network, a modem communications path, or the like. The computer network may include a wide area network (WAN), a local area network (LAN), an Intranet, and/or the Internet.

The processing device 102 may comprise a processor 104, a memory 106, input/output interfaces 108, 118, a video interface 110, the discrete event simulation and statistical analysis module 112, and a bus 114. Bus 114 may permit communication among the components of the processing device 102.

Processor 104 may include at least one conventional processor or microprocessor that interprets and executes instructions. Memory 106 may be a random access memory (RAM) or another type of dynamic storage device that stores information and instructions for execution by processor 104. Memory 106 may also include a read-only memory (ROM) which may include a conventional ROM device or another type of static storage device that stores static information and instructions for processor 104.

The video interface 110 is connected to the display 116 and provides video signals from the computer 102 for display on the display 116. User input to operate the computer 102 can be provided by one or more input devices 120, 122 via the input/output interface 118. For example, an operator can use the keyboard 120 and/or a pointing device such as the mouse 122 to provide input to the computer 102.

The computer system 100 and processing device 102 may perform such functions in response to processor 104 by executing sequences of instructions contained in a tangible, computer-readable medium, such as, for example, memory 106. Such instructions may be read into memory 106 from another tangible, computer-readable medium, such as a storage device or from a separate device via communication interface 108.

The computer system 100 and processing device 102 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the computer system 100 and processing device 102. Generally, program modules include routine programs, objects, components, data structures, etc. that perform particular tasks or implement particular abstract data types. Moreover, those skilled in the art will appreciate that other embodiments of the invention may be practiced in computer environments with many types of communication equipment and computer system configurations, including cellular devices, mobile communication devices, personal computers, hand-held devices, multi-processor systems, microprocessor-based or programmable consumer electronics, and the like.

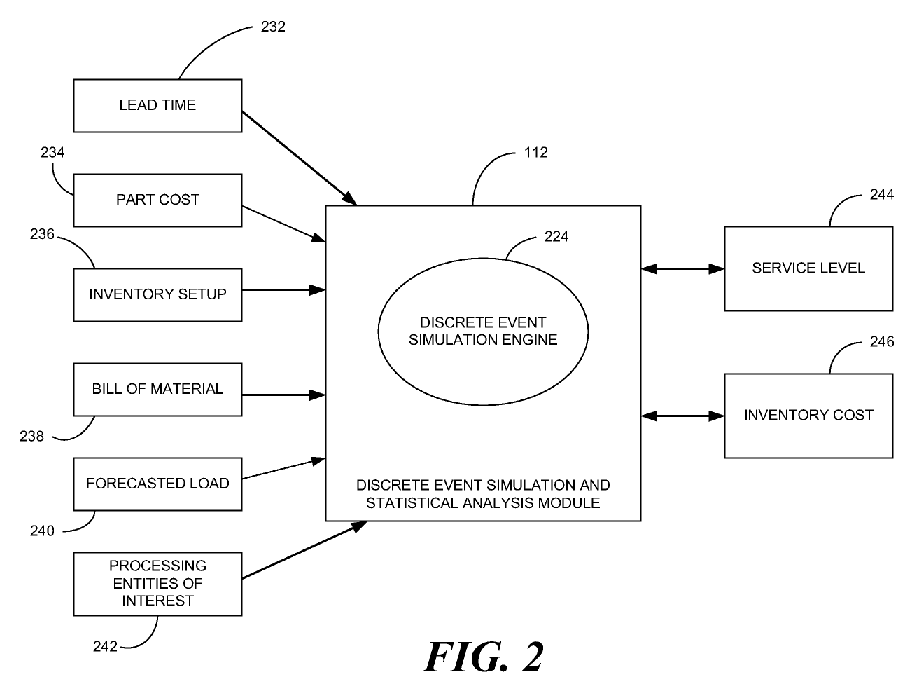

Referring now to FIG. 2, the block diagram illustrates exemplary inputs to and outputs from the discrete event simulation and statistical analysis module 112. The discrete event simulation and statistical analysis module 112 may include a discrete event simulation engine 224. According to an exemplary aspect, the inputs may include the lead time 232 or delay to get parts from a supplier and the part cost 234. The lead time 232 may be expressed via a probability density function, and the part cost may be in the currency of interest to the user. The inputs may also include inventory setup 236, which includes the number of parts (start, minimum, and maximum) and the replenishment strategy for each, and bill of material (BOM) 238, which includes all part numbers required to build a product. The inputs may further include forecasted load 240 or expected product demand during a given time interval, and processing entities of interest 242 such as, for example, package handlers or builders. The processing entities 242 may include capacity, labor availability, order processing methodology, and customer required shipment date. Capacity may be expressed in the form of time to perform certain activities, while labor availability may include the number of shifts, daily schedules, weekend shifts, etc. Order processing methodology may include delay or priority algorithms in handling orders, and the shipment date may include timeliness or tardiness of orders expressed as an algorithm. Thus, the inputs may include internal and/or external transportation delays with respect to one or more links in a transportation network of a supply chain for a product. According to some aspects, the inputs may include demand, direct/indirect labor costs, and/or labor utilization (not shown).

The outputs of the discrete event simulation and statistical analysis module 112 may include service-level 244, or percentage of on-time processed orders over a time interval of interest. Service-level 244 may include two types of categories: cumulative service-level and non-cumulative service-level. Cumulative service-level is calculated from the beginning of the time interval of interest, while non-cumulative service-level is calculated over shorter time periods. According to some aspects, non-cumulative service-level may be calculated weekly, daily, etc. Another output of the module 112 may comprise inventory cost 246. Inventory cost may include the total cost of having a given material in inventory and is calculated once every given time period. As the inputs and outputs 232-246 may have their own default formats, modifications may be made to ease the data transfer and analysis.

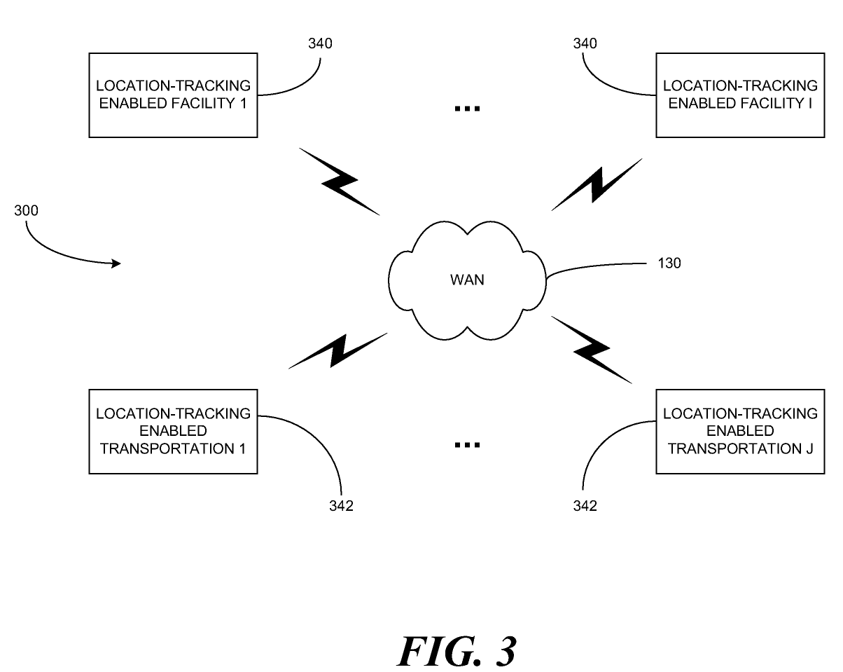

Referring now to FIG. 3, the block diagram illustrates an exemplary wide area location tracking infrastructure 300. The location tracking infrastructure 300 includes one or more facility data sources 340 and one or more transportation data sources 342 configured to communicate with the communication channel 130.

Such communication may be achieved via integration between, for example, a wide area network 130 and one or more location tracking technologies to provide wide range tracking of goods in wider areas. The location tracking technologies may include, for example, wireless local area network(s) (e.g., WiFi), the global positioning system (GPS), and/or radio frequency identification (RFID).

It should be appreciated by persons skilled in the art that as the tracking in a wide area becomes available, the facility and transportation delays and their historical values become available. According to various aspects, the historical values for a previous period of time (T) may be available. That period of time (T) may vary, for example, for different modes of transportation (e.g., air, ground, sea, etc.) and/or different types of facilities (e.g., supplier, manufacturing, distribution center, etc.). Thus, a monitor-collect-calculate process may continuously monitor the tracking information and can calculate and store the latest transportation delays or inventory costs of interest. Data sets of interest may be stored at any sampling rate to be referenced at a future time.

For illustrative purposes, an exemplary discrete event simulation and statistical analysis module 112 will be described below in relation to the block diagrams shown in FIGS. 1-3.

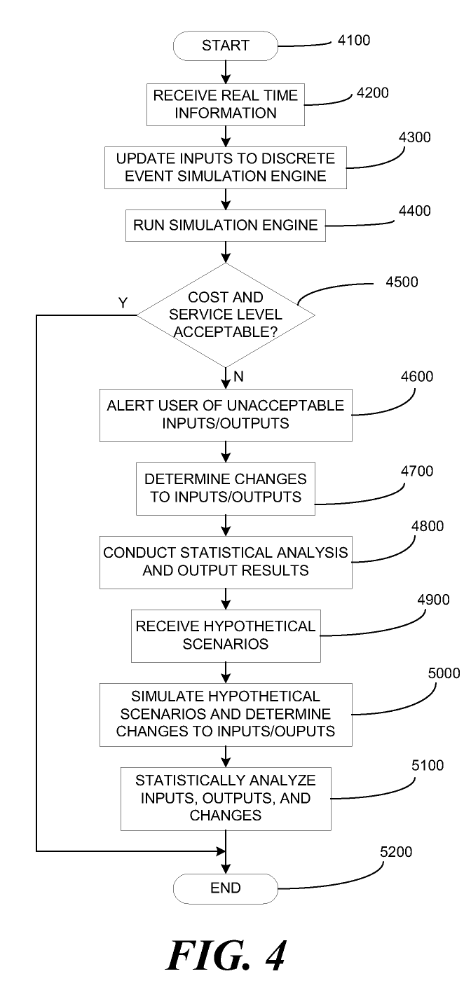

FIG. 4 is a flowchart illustrating some of the basic steps associated with an exemplary supply chain simulation and analysis process in accordance with a possible embodiment of the invention. The process begins at step 4100. The process may be commenced continuously every given time period t₁. For example, t₁ may comprise a desired number of seconds, minutes, hours, or the like. Control then continues to step 4200 where the discrete event simulation and statistical analysis module 112 receives real-time information regarding delays from at least one link in a transportation network of a product supply chain.

Communication of the real-time information may be achieved via integration between the discrete event simulation and statistical analysis module 112, for example, via an associated wide area network 130, and one or more location tracking technologies configured to provide wide range tracking of goods in wider areas. The location tracking technologies may include, for example, wireless local area network(s) (e.g., WiFi), the global positioning system (GPS) and/or radio frequency identification (RFID). Control proceeds to step 4300.

Next, in step 4300, the discrete event simulation and statistical analysis module 112 updates appropriate inputs to a discrete event simulation engine for a product supply chain based on the received information. Previous inputs to the engine may be stored, for example, via memory 106 or in any other conventional manner, for a period of time (T), as determined by desires of a user. The process continues to step 4400 where the discrete event simulation and statistical analysis module 112 runs the simulation engine to simulate events in the product supply chain based on the received real-time information. The engine may generate outputs representative of costs and/or service level relative to the product supply chain. The outputs may also be stored, for example, via memory 106 or in any other conventional manner, for a period of time (T), as determined by desires of a user. Control then proceeds to step 4500.

In step 4500, the discrete event simulation and statistical analysis module 112 determines whether the cost and/or service level, both of which can be output from the simulation engine, are acceptable. If the cost and service level are acceptable, control jumps to step 5200 where the process ends for the current time interval. As mentioned above, the process may re-commence at step 4100, when the given time interval t₁, which may be measured from the previous start at step 4100, is reached again.

If, in step 4500, it is determined that the cost and/or service level output is not acceptable, control proceeds to step 4600. In step 4600, the discrete event simulation and statistical analysis module 112 alerts the user of the unacceptable output(s), and control proceeds to step 4700. In step 4700, the module 112 determines the changes in the inputs to and outputs from the simulation engine in comparison with inputs and outputs from other time intervals during the stored time period (T). Control then continues to step 4800.

Next, in step 4800, the discrete event simulation and statistical analysis module 112 conducts and outputs the results of a statistical analysis of the inputs, outputs, and changes thereof relative to the simulation of the product supply chain. Control then proceeds to step 4900, where the module 112 receives one or more hypothetical, or “what-if,” supply chain scenarios for simulation and analysis. Control continues to step 5000, where the discrete event simulation and statistical analysis module 112 simulates the hypothetical supply chain scenarios and determines changes to the inputs and outputs of the simulation. Control then proceeds to step 5100, where the module 112 statistically analyzes the inputs, outputs, and changes thereof. Control then continues to step 5200, where the process ends.

It should be appreciated that the supply chain simulation methods and devices may be incorporated with a supply chain optimization model, such as that disclosed in U.S. application Ser. No. 11/760,132, filed on Jun. 8, 2007, and entitled “APPARATUS AND METHODS FOR OPTIMIZING SUPPLY CHAIN CONFIGURATIONS.”

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A machine-implemented method for simulating a supply chain for a product, the method comprising:
receiving real-time information regarding delays from at least one link in a product supply chain;
simulating events in the product supply chain based on said received information; and
determining, based on said simulating, whether at least one of costs and level of service relative to the product is unacceptable.

2. The method of claim 1, wherein said at least one link comprises at least one of a tracking-enabled transportation link and a tracking-enabled facility.

3. The method of claim 1, further comprising alerting a user as to whether at least one of costs and level of service is unacceptable.

4. The method of claim 1, further comprising:
determining changes between said received information and previously stored data and between at least one output of said simulating and previous outputs of said simulating.

5. The method of claim 4, further comprising statistically analyzing said changes.

6. The method of claim 5, further comprising:
receiving a hypothetical supply chain scenario associated with at least one link in the product supply chain;
simulating the hypothetical supply chain scenario; and
determining, based on said simulating of the hypothetical supply chain scenario, whether at least one of costs and level of service relative to the product is acceptable.

7. The method of claim 6, further comprising:
statistically analyzing changes between said hypothetical supply chain scenario and previously stored data and previous outputs of said simulating of events in the supply chain.

8. A processing device comprising:
at least one processor;
a memory including instructions for the processor; and
a bus for providing communication between the processor and the memory, the memory further comprising instructions for receiving real-time information regarding delays from at least one link in a product supply chain, simulating events in the product supply chain based on said received information, and determining, based on said simulating, whether at least one of costs and level of service relative to the product is unacceptable.

9. The processing device of claim 8, wherein said at least one link comprises at least one of a tracking-enabled transportation link and a tracking-enabled facility.

10. The processing device of claim 8, wherein the memory further comprises instructions for alerting a user as to whether at least one of costs and level of service is unacceptable.

11. The processing device of claim 8, wherein the memory further comprises instructions for determining changes between said received information and previously stored data and between at least one output of said simulating and previous outputs of said simulating.

12. The processing device of claim 11, wherein the memory further comprises instructions for statistically analyzing said changes.

13. The processing device of claim 12, wherein the memory further comprises instructions for receiving a hypothetical supply chain scenario associated with at least one link in the product supply chain, simulating the hypothetical supply chain scenario, and determining, based on said simulating of the hypothetical supply chain scenario, whether at least one of costs and level of service relative to the product is acceptable.

14. The processing device of claim 13, wherein the memory further comprises instructions for statistically analyzing changes between said hypothetical supply chain scenario and previously stored data and previous outputs of said simulating of events in the supply chain.

15. A tangible, machine-readable medium having instructions for at least one processor recorded thereon, the medium comprising:
instructions for receiving real-time information regarding delays from at least one link in a product supply chain;
instructions for simulating events in the product supply chain based on said received information; and
instructions for determining, based on said simulating, whether at least one of costs and level of service relative to the product is unacceptable.

16. The medium of claim 15, wherein said at least one link comprises at least one of a tracking-enabled transportation link and a tracking-enabled facility.

17. The medium of claim 15, wherein the memory further comprises instructions for alerting a user as to whether at least one of costs and level of service is unacceptable.

18. The medium of claim 15, wherein the memory further comprises:
instructions for determining changes between said received information and previously stored data and between at least one output of said simulating and previous outputs of said simulating; and
instructions for statistically analyzing said changes.

19. The medium of claim 18, wherein the memory further comprises instructions for receiving a hypothetical supply chain scenario associated with at least one link in the product supply chain, simulating the hypothetical supply chain scenario, and determining, based on said simulating of the hypothetical supply chain scenario, whether at least one of costs and level of service relative to the product is acceptable.

20. The medium of claim 19, wherein the memory further comprises instructions for statistically analyzing changes between said hypothetical supply chain scenario and previously stored data and previous outputs of said simulating of events in the supply chain.
